(19) United States
(12) Patent Application Publication
(10) Pub. No.: US 2026/0023271 A1
(43) Pub. Date: Jan. 22, 2026

(54) DISPLAY DEVICE

(71) Applicant: Japan Display Inc., Tokyo (JP)

(72) Inventors: Takuya NISHIMOTO, Tokyo (JP); Hirofumi OHIRA, Tokyo (JP)

(73) Assignee: Japan Display Inc., Tokyo (JP)

(21) Appl. No.: 19/246,771

(22) Filed: Jun. 24, 2025

(30) Foreign Application Priority Data
Jun. 28, 2024 (JP) 2024-105186

(51) Int. Cl. G02B 30/32; G06F 3/044

(52) U.S. Cl. CPC G02B 30/32; G06F 3/0448

(57) ABSTRACT

According to an aspect, a display device includes: a display region configured to display an image; a parallax barrier for enabling an image output from the display region to be visually recognized as a parallax image; and a sensor provided to overlap the parallax barrier. The parallax barrier includes a light shield and a plurality of slits that are free of the light shield and extend in a predetermined direction to transmit light. The sensor includes an electrode and a wiring electrically coupled to the electrode. At least the electrode has a mesh structure formed of a plurality of fine metal lines extending in a predetermined direction. The wiring includes fine metal lines in a coupled state adjacent to a fine metal line in a non-coupled state. The direction in which the fine metal lines extend and the direction in which the slits extend are different from each other.

### CROSS-REFERENCE TO RELATED APPLICATION

This application claims the benefit of priority from Japanese Patent Application No. 2024-105186, filed on Jun. 28, 2024, the entire contents of which are incorporated herein by reference.

### BACKGROUND

### 1. Technical Field

What is disclosed herein relates to a display device.

### 2. Description of the Related Art

A display device is known in which a parallax barrier is provided between a liquid crystal display panel and a light source to block part of light projected onto the liquid crystal display panel from the light source so that a three-dimensional (3D) image can be visually recognized. Such a display device is disclosed in, for example, Japanese Patent Application Laid-open Publication No. 2008-175875.

It is possible to achieve a display device with added value by placing various sensors over a parallax barrier. However, a slit that is an opening between light shields is potentially blocked when a sensor is placed to overlap the parallax barrier. When the slit is blocked, light does not pass therethrough and thus an obtained image is dark, which is not preferable.

For the foregoing reasons, there is a need for a display device capable of preventing decrease in light transmittance even when a sensor is placed to overlap a parallax barrier.

### SUMMARY

According to an aspect, a display device includes: a display region configured to display an image; a parallax barrier for enabling an image output from the display region to be visually recognized as a parallax image; and a sensor provided to overlap the parallax barrier. The parallax barrier includes a light shield and a plurality of slits that are free of the light shield and extend in a predetermined direction to transmit light. The sensor includes an electrode and a wiring electrically coupled to the electrode. At least the electrode has a mesh structure formed of a plurality of fine metal lines extending in a predetermined direction. The wiring includes fine metal lines in a coupled state adjacent to a fine metal line in a non-coupled state. The direction in which the fine metal lines extend and the direction in which the slits extend are different from each other.

### BRIEF DESCRIPTION OF THE DRAWINGS

FIG. 1 is a schematic diagram illustrating the mechanism of a display device configured to produce stereoscopic viewing;

FIG. 2 is a schematic diagram illustrating the optical axes of light from a first panel to a plurality of viewpoints;

FIG. 3 is a diagram illustrating an exemplary configuration of a sensor;

FIG. 4 is a schematic diagram illustrating a schematic sectional configuration of a detection system to which a display device according to an embodiment is applied;

FIG. 5 is a block diagram illustrating an exemplary configuration of a detector of the display device according to the embodiment;

FIG. 6 is a schematic diagram illustrating the positional relation between the position of a detection target object in a space on a detection region and each electrode;

FIG. 7 is a schematic diagram illustrating the spatial coordinate of the detection target object in the space on the detection region;

FIG. 8 is a flowchart illustrating an example of processing by a processing circuit;

FIG. 9A is a diagram illustrating an example of a mesh structure formed of fine metal lines;

FIG. 9B is a diagram illustrating another example of a mesh structure formed of fine metal lines;

FIG. 10 is a diagram illustrating a comparative example of electrodes formed of fine metal lines;

FIG. 11 is a diagram illustrating a mesh structure formed of fine metal lines extending in the same direction as the electrodes illustrated in FIG. 10;

FIG. 12 is a diagram illustrating an example of a parallax barrier;

FIG. 13 is a diagram illustrating a state in which the mesh structure illustrated in FIG. 11 and the parallax barrier illustrated in FIG. 12 are placed to overlap each other;

FIG. 14 is a diagram illustrating an example of electrodes according to the present disclosure;

FIG. 15 is a diagram illustrating a mesh structure formed of fine metal lines extending in the same direction as the electrodes illustrated in FIG. 14;

FIG. 16 is a diagram illustrating an example of the parallax barrier; and

FIG. 17 is a diagram illustrating a state in which the mesh structure illustrated in FIG. 15 and the parallax barrier illustrated in FIG. 16 are placed to overlap each other.

### DETAILED DESCRIPTION

Aspects (embodiments) of the present disclosure will be described below in detail with reference to the accompanying drawings. Contents described below in the embodiments do not limit the present disclosure.

Components described below include those that could be easily thought of by the skilled person in the art and those identical in effect. Components described below may be combined as appropriate. What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

### Mechanism of Stereoscopic Viewing

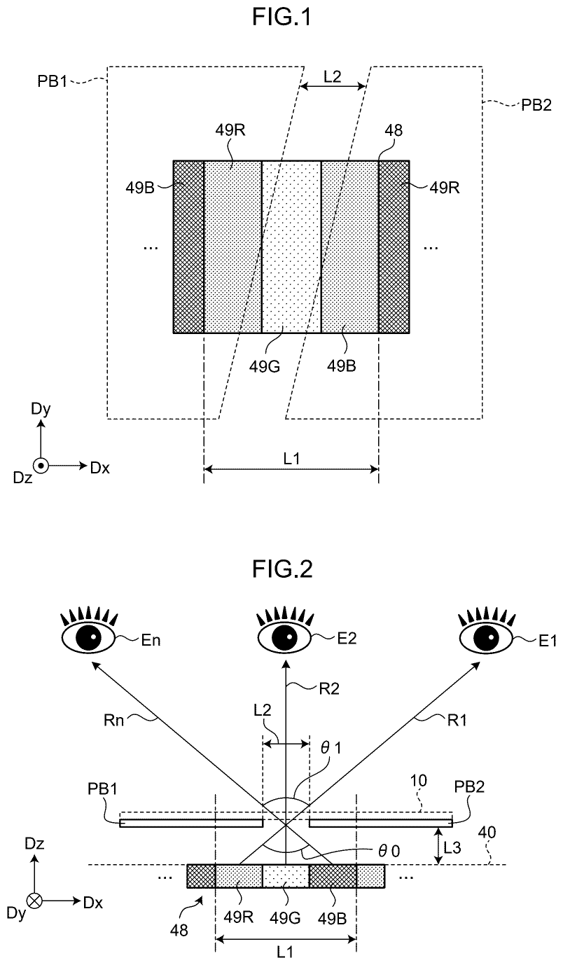

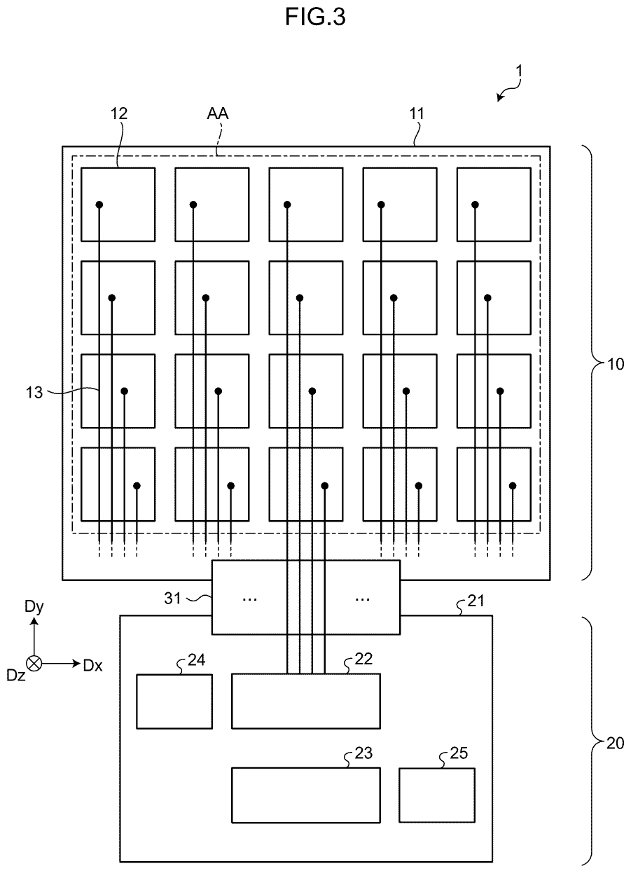

Before description of the embodiment, the mechanism of a display device configured to produce stereoscopic viewing will be described below with reference to FIGS. 1 and 2.

FIG. 1 is a schematic diagram illustrating the mechanism of a display device configured to produce stereoscopic viewing. FIG. 2 is a schematic diagram illustrating optical axes R1, R2, . . . , Rn of light from a first panel 40 to a plurality of viewpoints E1, E2, En.

A pixel 48 illustrated in FIGS. 1 and 2 includes a first sub pixel 49R, a second sub pixel 49G, and a third sub pixel 49B. Hereinafter, the term “sub pixels 49” collectively refers to the first sub pixel 49R, the second sub pixel 49G, and the third sub pixel 49B. A plurality of pixels 48 are provided on the first panel 40. The first panel 40 displays and outputs an image by luminance control of the sub pixels 49 included in each of the pixels 48. Hereinafter, two directions along an image display surface of the first panel 40 on which the pixels 48 are provided are referred to as a first direction Dx and a second direction Dy. The first direction Dx and the second direction Dy are orthogonal to each other. In addition, a direction orthogonal to the first direction Dx and the second direction Dy is referred to as a third direction Dz.

FIG. 1 exemplarily illustrates the pixels 48 that has a quadrilateral shape and are called stripe-type color pixels in which the sub pixels 49 are arranged in the order of the first sub pixel 49R, the second sub pixel 49G, and the third sub pixel 49B from one side in the first direction Dx toward the other side. However, the disposition and shapes of the sub pixels 49 included in each pixel 48 are not limited thereto but may be changed as appropriate. Furthermore, FIG. 1 and the other diagrams exemplarily illustrate the pixels 48 that achieves color display output as the first sub pixel 49R performs output in red (R), the second sub pixel 49G performs output in green (G), and the third sub pixel 49B performs output in blue (B). However, the combination and number of colors of the sub pixels 49 included in each pixel 48 are not limited thereto but may be changed as appropriate.

A parallax barrier is formed between the first panel 40 and each of viewpoints E1, E2, . . . , En of a user who recognizes an image by visually recognizing light from the first panel 40. The parallax barrier includes, for example, a light shield PB1 and a light shield PB2 illustrated in FIGS. 1 and 2, and an opening formed between the light shields PB1 and PB2. The opening is a slit that is free of the light shields and extends in a predetermined direction to transmit light. Hereinafter, the opening is also referred to as a “slit”. In FIGS. 1 and 2, the opening width of the opening in the first direction Dx is denoted by a width L2.

The light shields PB1 and PB2 block light between the first panel 40 and the viewpoints E1, E2, . . . , En. Thus, among light traveling from the first panel 40 toward the viewpoints E1, E2, . . . , En side, light having an optical axis on which the light shield PB1 or the light shield PB2 is located is blocked and not visually recognized by the user.

FIG. 2 schematically illustrates optical axes R1, R2, . . . , Rn of light traveling from the first panel 40 toward the viewpoints E1, E2, . . . , En through the opening of the parallax barrier. The optical axis R1 is the optical axis of light traveling from the first sub pixel 49R toward the viewpoint E1. The optical axis R2 is the optical axis of light traveling from the second sub pixel 49G toward the viewpoint E2. The optical axis Rn is the optical axis of light traveling from the third sub pixel 49B toward the viewpoint En. Two of the viewpoints E1, E2, . . . , En are viewpoints of the two eyes of the user (human). In this manner, stereoscopic viewing is achieved with the optical axes R1, R2, . . . , Rn of light traveling from the sub pixels 49 toward the different viewpoints E1, E2, . . . , En, respectively. Moreover, different stereoscopic images can be visually recognized from different viewpoints as the user changes its relative position to the first panel 40 and the parallax barrier.

The number (n) of optical axes R1, R2, . . . , Rn is an arbitrary natural number. As the number n is larger, stereoscopic viewing is possible at a larger number of viewpoints E1, E2, . . . , En.

An incident angle range θ0 of light entering the opening of the parallax barrier and an emission angle range θ1 of light that can travel from the first panel 40 toward the viewpoints E1, E2, . . . , En through the opening of the parallax barrier are determined in accordance with the width L2 and an interval L3 between the first panel 40 and the parallax barrier. An emission area L1 of the first panel 40 in which light can be emitted through one opening of the parallax barrier is determined in accordance with the emission angle range θ1. The emission area L1 has a width in the first direction Dx. The width of the emission area L1 in the first direction Dx is larger than the width L2.

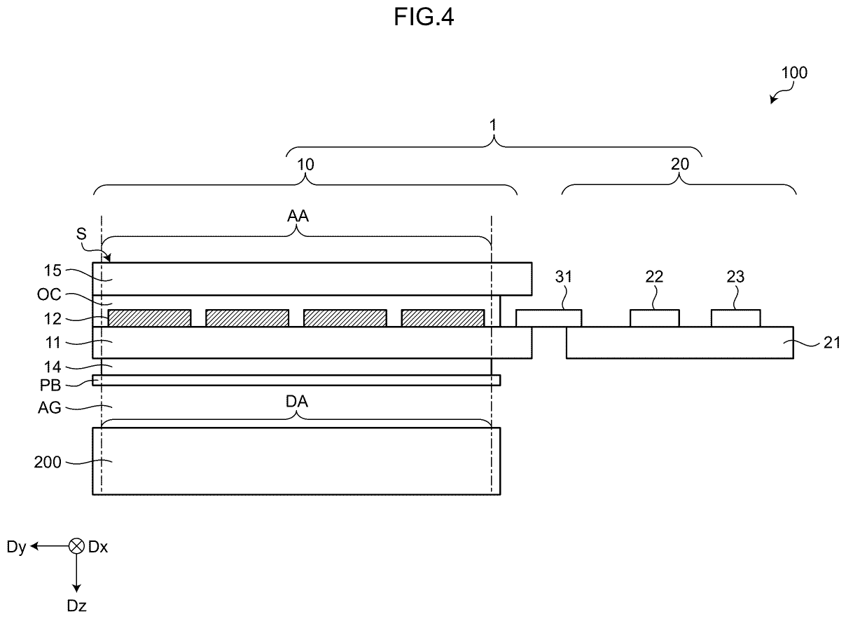

A sensor 10 is provided on the third direction Dz side of the parallax barrier including the light shields PB1 and PB2. FIG. 3 is a diagram illustrating an exemplary configuration of the sensor 10. The sensor 10 includes a sensor substrate 11, a plurality of electrodes 12 provided in a detection region AA of the sensor substrate 11, and wirings 13 extending from the respective electrodes 12. The sensor 10 is coupled to a detector 20. The detector 20 includes a control substrate 21, a detection circuit 22, a processing circuit 23, a power circuit 24, and an interface circuit 25.

The detection region AA of the sensor substrate 11 is a region provided with the electrodes 12 arranged in a matrix of rows and columns in the Dx direction (first direction) and the Dy direction (second direction). The sensor substrate 11 is, for example, a glass substrate or a light-transmitting flexible printed circuit board (FPC).

A display device 1 according to the present embodiment has a function to detect the position of a detection target object in a space on the detection region AA of the sensor substrate 11 and calculate the coordinates of the detection target object. In the present disclosure, the Dx direction (first direction) and the Dy direction (second direction) are orthogonal to each other in the detection region AA. Moreover, in the present disclosure, a direction orthogonal to the Dx direction (first direction) and the Dy direction (second direction) is referred to as the Dz direction (third direction).

Although 5×4 (=20) electrodes 12 with five electrodes 12 in the Dx direction and four electrodes 12 in the Dy direction are provided in the example illustrated in FIG. 3, the number of electrodes 12 provided in the detection region AA of the sensor substrate 11 is not limited thereto.

The control substrate 21 is electrically coupled to the sensor substrate 11 through a wiring substrate 31. The wiring substrate 31 is, for example, a flexible printed circuit board. Each electrode 12 in the sensor 10 is coupled to the detection circuit 22 of the detector 20 through the wiring substrate 31.

The control substrate 21 is provided with the detection circuit 22, the processing circuit 23, the power circuit 24, and the interface circuit 25. The control substrate 21 is, for example, a rigid substrate.

The detection circuit 22 generates a detected value of each electrode 12 based on a detection signal of the electrode 12, which is output from the sensor substrate 11. The detection circuit 22 is, for example, an analog front end (AFE) IC.

The processing circuit 23 generates a spatial coordinate indicating the position of a detection target object (for example, an operator's finger) in a space on the detection region AA based on the detected value of each electrode 12, which is output from the detection circuit 22. The processing circuit 23 may be, for example, a programmable logic device (PLD) such as a field programmable gate array (FPGA) or may be a micro control unit (MCU).

The power circuit 24 is a circuit configured to supply power to the detection circuit 22 and the processing circuit 23.

The interface circuit 25 is, for example, a universal serial bus (USB) controller IC and is a circuit configured to control communication between the processing circuit 23 and a host controller (not illustrated) of a host device on which a detection system is mounted.

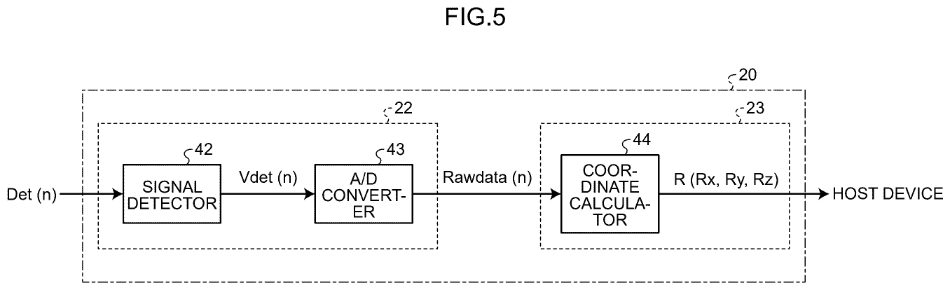

FIG. 4 is a schematic diagram illustrating a schematic sectional configuration of a display system to which the display device according to the embodiment is applied.

This display system 100 includes the display device 1 and a display panel 200. The display panel 200 corresponds to a display region configured to display an image. The display panel 200 is disposed facing the sensor 10 of the display device 1 with an air gap AG therebetween. The sensor 10 of the display device 1 is disposed such that the detection region AA of the sensor 10 and a display region DA of the display panel 200 are arranged in the Dz direction (third direction) to overlap each other in a plan view. The display panel 200 is, for example, a liquid crystal display (LCD). The display panel 200 may be, for example, an organic EL display (organic light emitting diode or OLED), an inorganic EL display (micro LED or mini LED), or a transparent display that displays an image on a transmissive display surface.

The sensor 10 includes the sensor substrate 11, the electrodes 12, a shield 14, and a cover glass 15. The sensor 10 is configured such that a parallax barrier PB, the shield 14, the sensor substrate 11, the electrodes 12, and the cover glass 15 are stacked in the stated order from the display panel 200 side. Hereinafter, the upper surface of the cover glass 15 provided at the uppermost layer is also referred to as a “detection surface S”. The detection surface S is not limited to the upper surface of the cover glass 15. In the present disclosure, the detection surface S is a reference surface for defining the distance to a detection target object in the Dz direction (third direction) and may be, for example, the upper surface of the electrodes 12.

The shield 14 is provided on a first surface of the sensor substrate 11 on the display panel 200 side. The electrodes 12 is provided on a second surface of the sensor substrate 11 on the back side of the first surface. The cover glass 15 is provided on the second surface of the sensor substrate 11 with a bonding layer OC interposed therebetween. A light-transmitting bonding agent is desirably employed as the bonding layer OC. The bonding layer OC may be formed of a light-transmitting film having double-sided adhesiveness, such as an optical clear adhesive (OCA). The parallax barrier PB for implementing the light shields PB1 and PB2 (refer to FIG. 2) is provided on the display panel 200 side of the shield 14. The parallax barrier PB is provided so as to overlap the display panel 200 with the air gap AG interposed therebetween. The parallax barrier PB enables an image output from the display region to be visually recognized as a parallax image.

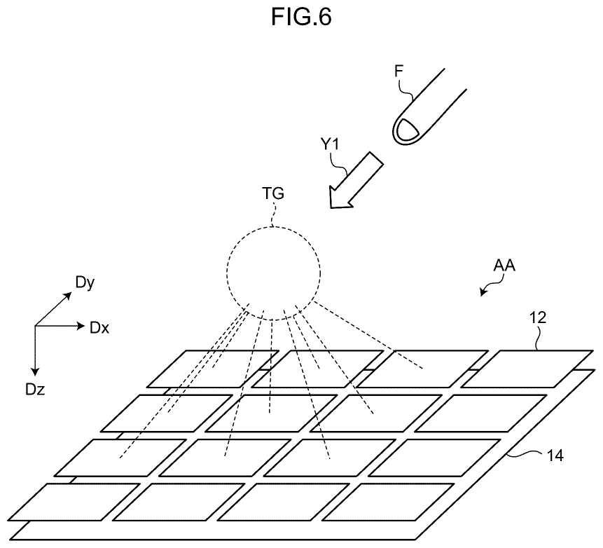

FIG. 5 is a block diagram illustrating an exemplary configuration of the detector of the display device according to the embodiment. In the present disclosure, the detector 20 calculates the coordinates of a detection target object in the space on the detection region AA.

As illustrated in FIG. 5, the detector 20 includes a signal detector 42, an analog-to-digital (A/D) converter 43, and a coordinate calculator 44. The signal detector 42 and the A/D converter 43 are included in the detection circuit 22. The coordinate calculator 44 is included in the processing circuit 23.

The signal detector 42 generates an output value Rawdata(n) of each electrode 12 based on a detection signal Det (n) (n is a natural number of 1 to N, where N is the number of electrodes in the detection region AA) of the electrode 12, which is output from the sensor substrate 11. The A/D converter 43 samples the output value of each electrode 12 to convert the output value of the electrode 12 into a digital signal.

The coordinate calculator 44 calculates the spatial coordinates R(Rx, Ry, Rz) of a position where the detection target object exists based on the output value Rawdata(n) of each electrode 12.

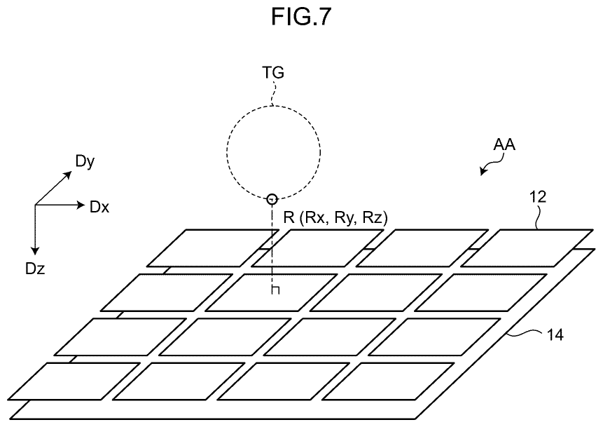

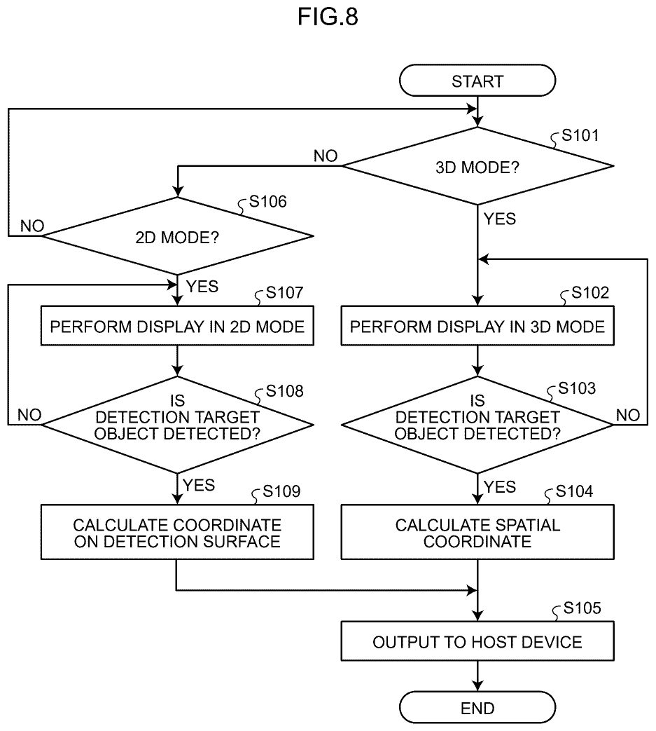

FIG. 6 is a schematic diagram illustrating the positional relation between the position of the detection target object in the space on the detection region and each electrode. FIG. 7 is a schematic diagram illustrating the spatial coordinate of the detection target object in the space on the detection region. FIGS. 6 and 7 illustrate an example in which a stereoscopic image target TG exists in the space on the detection region AA.

As illustrated in FIG. 6, in the present example, the 12 electrodes 12 are provided in the detection region AA. The target TG is, for example, a 3D image of a press button. When a detection target object F such as an operator's finger approaches the target TG as illustrated with arrow Y1 to operate the press button, a capacitance corresponding to the distance between the detection target object F existing in the space on the detection region AA and each electrode 12 is generated at the electrode 12 in the detection region AA, and the output value Rawdata(n) corresponding to the capacitance is acquired by the detection circuit 22. In this manner, the sensor 10 outputs the value of a capacitance generated between each electrode 12 and the detection target object F.

The processing circuit 23 extracts the spatial coordinates R(Rx, Ry, Rz) indicating the position of the detection target object F in the space on the detection region AA illustrated in FIG. 7 by using the output value Rawdata(n) of each electrode 12, which is generated by the detection circuit 22.

In the present disclosure, the spatial coordinates R(Rx, Ry, Rz) correspond to the position of the detection target object F existing in the space on the detection surface S. The spatial coordinates R(Rx, Ry, Rz) include X-directional first data Rx corresponding to a position in the Dx direction (first direction) on the detection region AA, Y-directional second data Ry corresponding to a position in the Dy direction (second direction) on the detection region AA, and Z-directional third data Rz corresponding to a position in the Dz direction (third direction) orthogonal to the Dx direction (first direction) and the Dy direction (second direction).

The processing circuit 23 outputs the coordinates calculated by the coordinate calculator 44. The coordinates calculated by the coordinate calculator 44 are transmitted to the host device through the interface circuit 25. The host device performs control in accordance with the coordinates transmitted from the processing circuit 23. Specifically, the host device executes processing in accordance with selection of the target TG such as image display of the press button. The present disclosure is not limited by the processing in the host device.

### Example of Processing by Processing Circuit

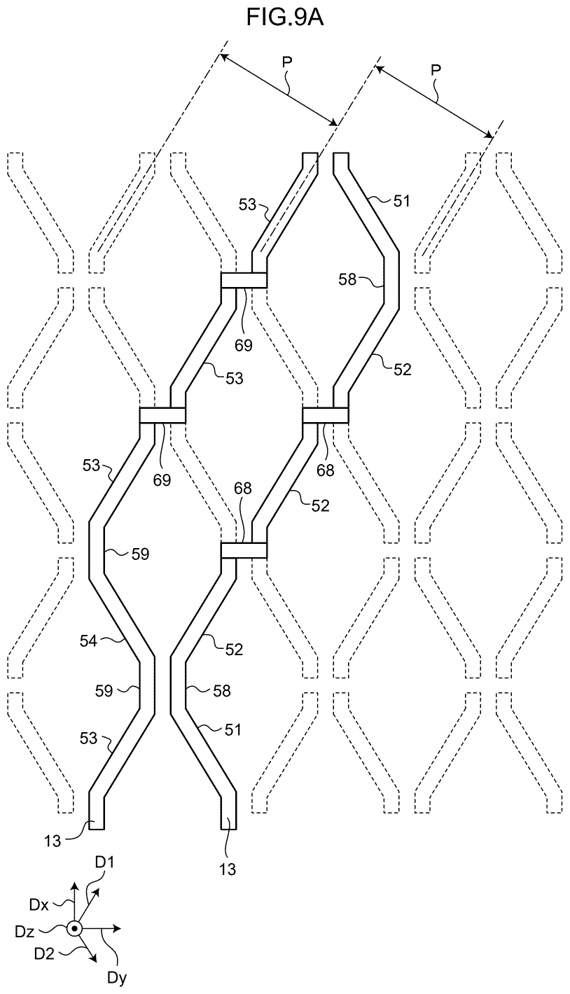

FIG. 8 is a flowchart illustrating an example of processing by the processing circuit 23. In the present example, different coordinates are calculated depending on whether an operation mode is a two-dimensional (2D) mode or a 3D mode. The 2D mode is an operation mode for displaying a 2D image. The 3D mode is an operation mode for displaying a 3D image.

In FIG. 8, the processing circuit 23 determines whether the current operation mode is the 3D mode (step S101). If the current operation mode is determined to be the 3D mode in the determination at step S101 (Yes at step S101), the process transitions to step S102 to perform display in the 3D mode (step S102).

During the display in the 3D mode, it is determined whether a detection target object such as a finger is detected (step S103). If a detection target object is determined to be detected in the determination at step S103 (Yes at step S103), the process transitions to step S104 to calculate the spatial coordinates of the detection target object (step S104). The calculated coordinates are output to the host device (step S105).

If it is determined that no detection target object is detected in the determination at step S103 (No at step S103), the display in the 3D mode is continued (step S102) and the determination of whether a detection target object is detected is continued (step S103).

If the current operation mode is not determined to be the 3D mode in the determination at step S101 (No at step S101), it is determined whether the current operation mode is the 2D mode (step S106). If the current operation mode is determined to be the 2D mode in the determination at step S106 (Yes at step S106), the process transitions to step S107 to perform display in the 2D mode (step S107).

During the display in the 2D mode, it is determined whether a detection target object such as a finger is detected (step S108). If a detection target object is determined to be detected in the determination at step S108 (Yes at step S108), its coordinates on the detection surface are calculated (step S109). The calculated coordinates are output to the host device (step S105).

If no detection target object is determined to be detected in the determination at step S108 (No at step S108), the display in the 2D mode is continued (step S107) and the determination of whether a detection target object is detected is continued (step S108).

If the current operation mode is not determined to be the 2D mode in the determination at step S106 (No at step S106), the process returns to step S101 to determine the current operation mode (step S101).

As described above, by performing processing in accordance with the operation mode, the processing circuit 23 can calculate coordinates in accordance with the current operation mode and output the detected coordinates to the host device. The host device can perform control in accordance with the coordinates.

### Example of Mesh Structure

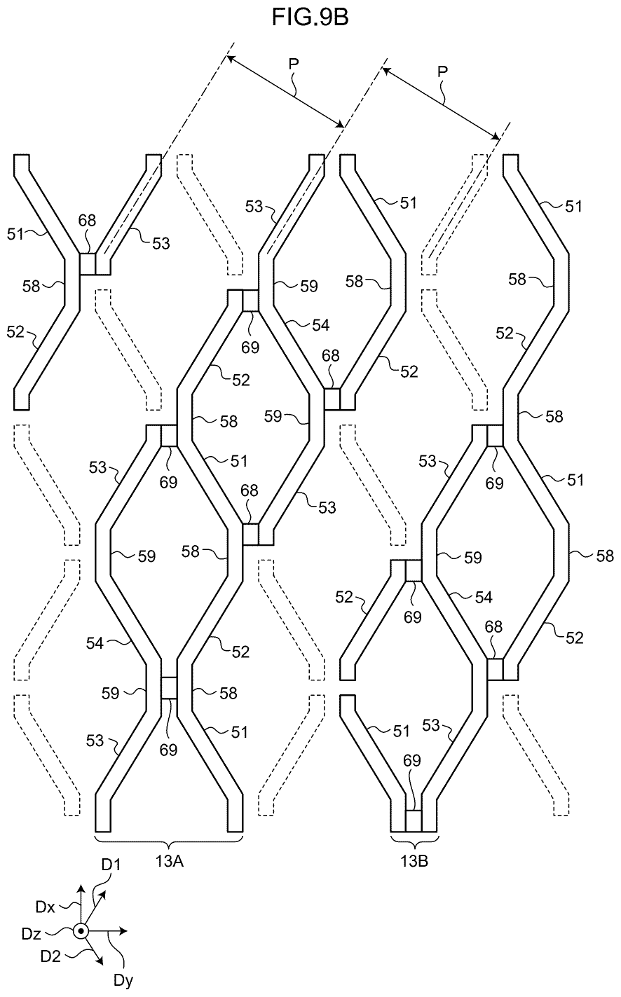

FIG. 9A is a diagram illustrating an example of a mesh structure formed of fine metal lines. FIG. 9A illustrates a plan view of an example of a mesh structure formed of fine metal lines constituting each electrode 12. The fine metal lines illustrated in FIG. 9A are provided at a constant pitch P. Each electrode 12 may be formed of a light-transmitting oxide electric conductor, but the light-transmitting oxide electric conductor has a resistance higher than that of metal with conductivity. For this reason, each electrode 12 is desirably formed of a metal layer with conductivity, but the metal layer has a light-shielding property, and accordingly, potentially becomes conspicuously visible when light from the display region DA of the display panel 200 is blocked. Thus, each electrode 12 is configured as a mesh structure formed of fine metal lines to make the fine metal lines visually inconspicuous while allowing light from the display region DA of the display panel 200 to transmit through spaces between the fine metal lines. In this manner, at least each electrode 12 has a mesh structure formed of a plurality of fine metal lines extending in a predetermined direction.

In FIG. 9A, portions illustrated with solid lines are electrically conductive portions of the fine metal lines. Portions illustrated with dashed lines are electrically non-conductive portions of the fine metal lines. With a structure in which the electrically conductive portions are continuous, it is possible to achieve effects equivalent to those of the wirings 13 (refer to FIG. 3). Specifically, the wirings 13 illustrated in FIG. 3 are configured with the electrically conductive portions and the electrically non-conductive portions in the mesh structure formed of fine metal lines. More specifically, each wiring 13 includes fine metal lines in a coupled state adjacent to a fine metal line in a non-coupled state.

Fine metal lines 52 and 53 extend in a direction D1 tilted relative to the first direction Dx (hereinafter also referred to as an extension direction D1). Fine metal lines 51 and 54 extend in a direction D2 tilted relative to the first direction Dx. Fine metal lines 58 and 59 extend in the first direction Dx.

The fine metal lines 51 and 52 are electrically connected to each other by being coupled through the fine metal line 58. The fine metal lines 53 and 54 are electrically connected to each other by being coupled through the fine metal line 59. Fine metal lines can be coupled to each other through a coupling member 68 or a coupling member 69.

In the case of FIG. 9A described above, one fine metal line is continuously coupled to form each wiring 13. Fine metal lines coupled in an annular shape may be continuously coupled to constitute wirings. FIG. 9B is a diagram illustrating another example of a mesh structure formed of fine metal lines.

FIG. 9B illustrates a plan view of an example of a mesh structure formed of fine metal lines constituting each electrode 12. As in the case of FIG. 9A, the fine metal lines illustrated in FIG. 9B are provided at a constant pitch P. As in the case of FIG. 9A, among the fine metal lines illustrated in FIG. 9B, the fine metal lines 51 and 52 are electrically connected to each other by being coupled through the fine metal line 58. The fine metal lines 53 and 54 are electrically connected to each other by being coupled through the fine metal line 59. Fine metal lines can be coupled to each other through the coupling member 68 or the coupling member 69.

In FIG. 9B, a wiring 13A is configured by continuously coupling annular fine metal lines. A wiring 13B is partially configured by using annular fine metal lines. The wirings 13A and 13B each include fine metal lines in a coupled state adjacent to a fine metal line in a non-coupled state. Electric signals can be transferred by employing any of the structures of the wirings 13, 13A, and 13B illustrated in FIGS. 9A and 9B. When annular fine metal lines are employed, the corresponding electric resistance can be reduced. Moreover, since each annular portion forms duplicated transfer paths for electric signals, an advantage is obtained in that even if one of the paths is interrupted, electric signals can be transferred as long as the other path is functional.

With an annular structure of electrically conductive portions and a connected structure of annular structures as described above with reference to FIGS. 9A and 9B, it is possible to achieve effects equivalent to those of the electrodes 12 (refer to FIG. 6) in a flat plate shape. Moreover, with continuous coupling of fine metal lines and continuous coupling of annular structures of fine metal lines, it is possible to achieve effects equivalent to those of the wirings 13 (refer to FIG. 3). Accordingly, in the mesh structure formed of fine metal lines, the electrodes 12 and the wirings 13 (refer to FIG. 3) are configured by coupling and non-coupling of portions of the fine metal lines. In other words, the electrodes 12 and the wirings 13 are configured with coupled and non-coupled states of fine metal lines.

### Example of Overlapping of Mesh Structure and Parallax Barrier

The following describes an example of overlapping of the mesh structure and the parallax barrier. The relation between the extension direction of each of the fine metal lines constituting the mesh structure and the extension direction of each of the slits of the parallax barrier is important to obtain effects of the present disclosure.

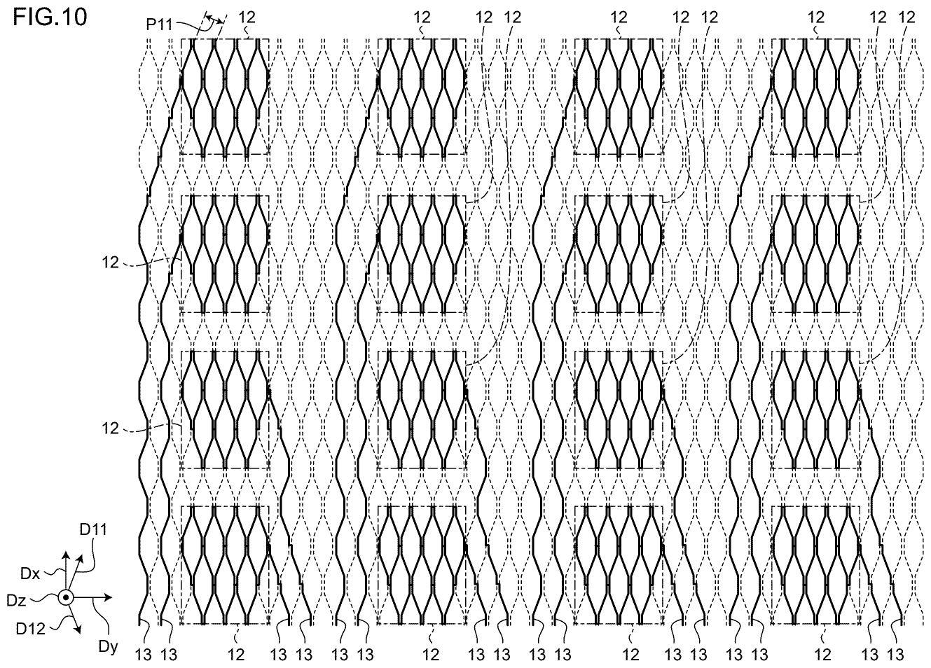

A comparative example will be first described to facilitate understanding of the effects of the present disclosure. FIG. 10 is a diagram illustrating a comparative example of the electrodes 12 formed of fine metal lines. As illustrated in FIG. 10, 12 electrodes 12 are configured by the fine metal lines. In addition, the wirings 13 are configured by the fine metal lines.

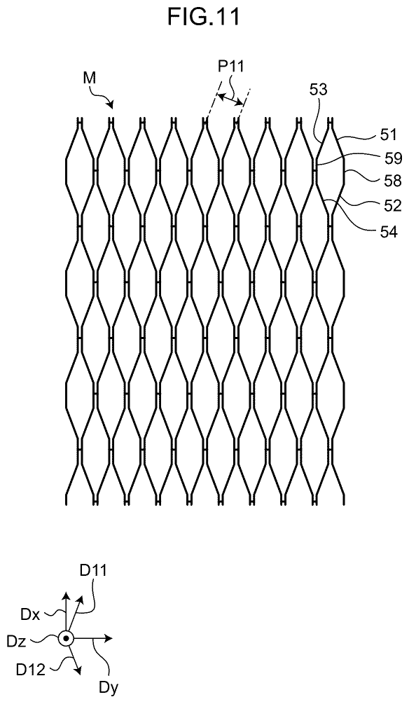

FIG. 11 is a diagram illustrating a mesh structure M configured with fine metal lines 51, 52, 53, and 54 extending in the same direction as the electrodes 12 illustrated in FIG. 10. As illustrated in FIG. 11, the fine metal lines are provided at a constant pitch P11.

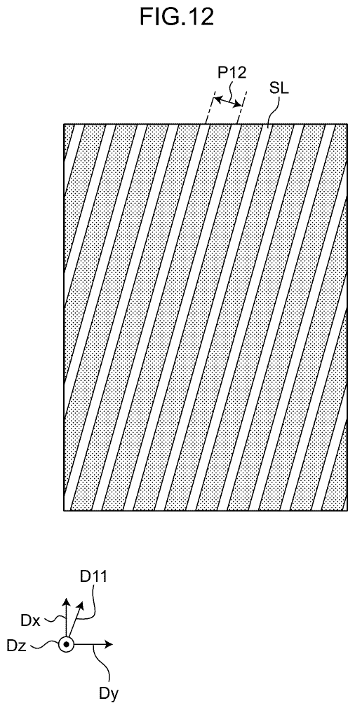

FIG. 12 is a diagram illustrating an example of the parallax barrier. As illustrated in FIG. 12, a plurality of slits SL of the parallax barrier are provided at a constant pitch P12. In the comparative example, an extension direction D11 of the fine metal lines constituting the mesh structure illustrated in FIG. 11 matches the extension direction D11 of the slits SL of the parallax barrier illustrated in FIG. 12.

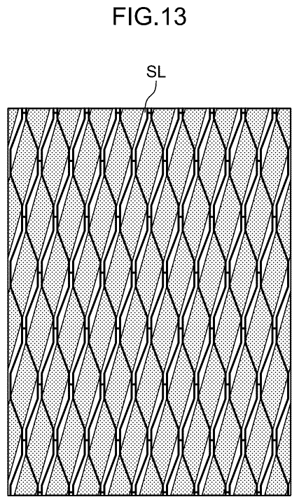

FIG. 13 is a diagram illustrating a state in which the mesh structure illustrated in FIG. 11 and the parallax barrier illustrated in FIG. 12 are placed to overlap each other. When the mesh structure illustrated in FIG. 11 and the parallax barrier illustrated in FIG. 12 are placed to overlap each other, the fine metal lines 52 and 53 forming the electrodes 12 or the wirings 13 (refer to FIG. 10) in the mesh structure block the slits SL of the parallax barrier in some cases.

Specifically, when the pitch P11 of the fine metal lines matches the pitch P12 of the slits SL as illustrated in FIG. 13, the slits SL of the parallax barrier are blocked by the fine metal lines. Since light does not pass through portions where the slits SL of the parallax barrier are blocked by the fine metal lines, an obtained image is dark, which is not preferable. Even when the pitch P11 of the fine metal lines is different from the pitch P12 of the slits SL of the parallax barrier, the extension direction D11 of the fine metal lines matches the extension direction D11 of the slits SL of the parallax barrier in some cases where one of the pitches P11 and P12 is an integral multiple of the other pitch. In such a case, the fine metal lines may block the slits SL of the parallax barrier.

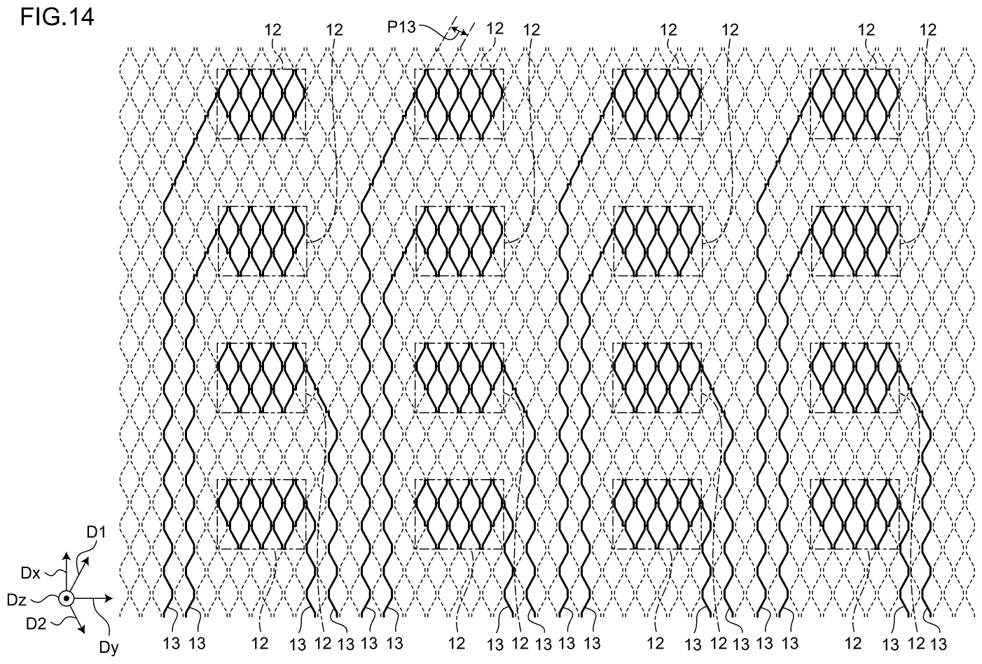

The case of the present disclosure will be described next. FIG. 14 is a diagram illustrating an example of the electrodes 12 according to the present disclosure. As illustrated in FIG. 14, 12 electrodes 12 are configured by fine metal lines.

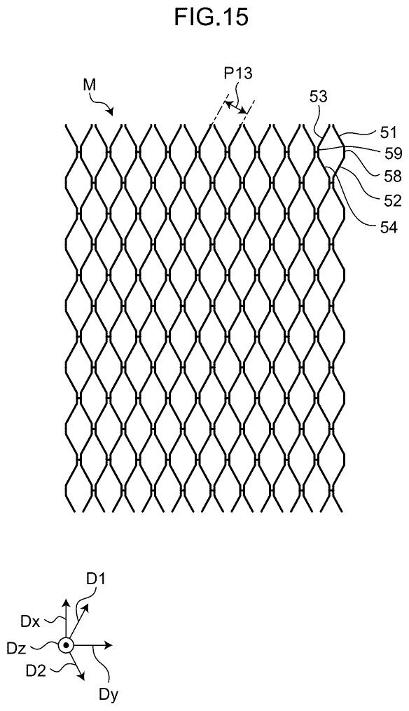

FIG. 15 is a diagram illustrating a mesh structure M formed of fine metal lines extending in the same direction as the electrodes 12 illustrated in FIG. 14. As illustrated in FIG. 15, the fine metal lines are provided at a constant pitch P13.

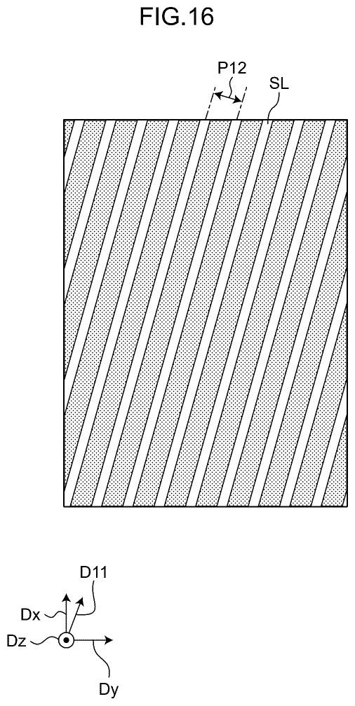

FIG. 16 is a diagram illustrating an example of the parallax barrier. As illustrated in FIG. 16, a plurality of slits SL of the parallax barrier are provided at a constant pitch P12. In the present disclosure, the extension direction D1 of the fine metal lines constituting the mesh structure illustrated in FIG. 15 does not match the extension direction D11 of the slits SL of the parallax barrier illustrated in FIG. 12. In other words, the fine metal lines constituting the mesh structure and the slits SL of the parallax barrier extend in different directions.

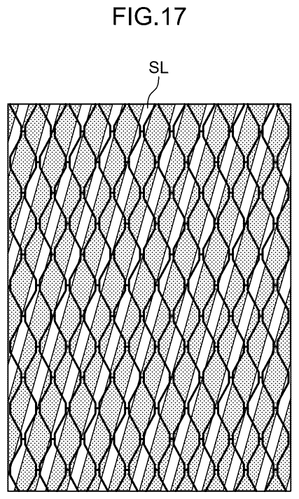

FIG. 17 is a diagram illustrating a state in which the mesh structure illustrated in FIG. 15 and the parallax barrier illustrated in FIG. 16 are placed to overlap each other. As illustrated in FIG. 17, when the mesh structure illustrated in FIG. 15 and the parallax barrier illustrated in FIG. 16 are placed to overlap each other, the slits SL of the parallax barrier are less blocked as compared to the case illustrated in FIG. 13. Accordingly, light sufficiently passes therethrough and an obtained image is not dark.

Moreover, since the pitch P13 of the fine metal lines and the pitch P12 of the slits SL of the parallax barrier are different from each other, light further passes therethrough and an image with favorable brightness is obtained. Thus, to sufficiently transmit light, at least the fine metal lines and the slits SL of the parallax barrier need to extend in different directions. To obtain more preferable results, the pitch P13 of the fine metal lines and the pitch P12 of the slits SL of the parallax barrier need to be different from each other.

What is claimed is:

1. A display device comprising:
a display region configured to display an image;
a parallax barrier for enabling an image output from the display region to be visually recognized as a parallax image; and
a sensor provided to overlap the parallax barrier, wherein
the parallax barrier includes a light shield and a plurality of slits that are free of the light shield and extend in a predetermined direction to transmit light,
the sensor includes an electrode and a wiring electrically coupled to the electrode, and
at least the electrode has a mesh structure formed of a plurality of fine metal lines extending in a predetermined direction,
the wiring includes fine metal lines in a coupled state adjacent to a fine metal line in a non-coupled state, and
the direction in which the fine metal lines extend and the direction in which the slits extend are different from each other.

2. The display device according to claim 1, wherein
the slits are provided at a predetermined pitch in a predetermined direction,
the fine metal lines are provided at a predetermined pitch in a predetermined direction, and
the pitch of the slits and the pitch of the fine metal lines are different from each other.

3. The display device according to claim 1, wherein the sensor detects the value of a capacitance generated between the electrode and a detection target object.

4. The display device according to claim 2, wherein the sensor detects the value of a capacitance generated between the electrode and a detection target object.
